(19) United States
(12) Patent Application Publication
(10) Pub. No.: US 2009/0032550 A1
(43) Pub. Date: Feb. 5, 2009

(54) DEVICE FOR EMITTING SOUND FROM A PERFUME SPRAY PACKAGE

(76) Inventor: Patrice Touron, Paris (FR)

Correspondence Address: LUCAS & MERCANTI, LLP, 475 PARK AVENUE SOUTH, 15TH FLOOR, NEW YORK, NY, 10016, US

(21) Appl. No.: 12/278,122

(22) PCT Filed: Feb. 5, 2007
(86) PCT No.: PCT/FR2007/000205

§ 371 Date: Aug. 1, 2008

(30) Foreign Application Priority Data
Feb. 6, 2006 (FR) 0601030

(51) Int. Cl. B67D 5/00; G01L 19/12; B67D 1/07; G08B 25/08

(52) U.S. Cl. 222/39; 222/192; 116/70; 340/692

(57) ABSTRACT

Device for emitting sound from a perfume spray package. This package is shaped so as to contain various microcomponents of a sound-emitting device, such as a microloudpeaker, electronic micorcomponents and microbatteries, operated by pressing on the push button of the spray bottle, the diffusion of the sound and the diffusion of a perfume having the same direction.

The invention relates to perfume vaporisers of a known type, fitted with a device for the emission of an audio message that is triggered during the operation of a button on this vaporiser.

These vaporisers thus associate with the emission of the fragrance of a perfume, that of an audio message whose musical and/or verbal content is considered to add to the pleasure procured by the vaporised perfume alone.

The invention relates to these vaporisers, and has as its first objective to be able to emulate the performance, from the simplest to the most sophisticated, of appliances known and widely available currently on the market, such as mobile telephones, miniature pocket recorders of the dictaphone type, or music players of the MP3 type. More precisely, the invention, in association with a vaporiser, aims to be able to emulate any type of sound-emitting device built from off-the-shelf microcomponents such as micro-batteries, microcircuits, microphones and micro-loudspeakers, with each of these microcomponents being selected for its small size, while still capable of delivering an audio output message of sufficient power so as to be easily audible even at a short distance from the audio source.

The invention has as its second objective to propose the packaging of a sound-emitting device for a vaporiser, that is of such an architecture that the joint emissions of fragrance and audio message are effected so as to confer upon the reception of the audio message by the user of the vaporiser an optimum of emission power and of reception intimacy.

The third objective of the invention is to propose such a packaging of the sound-emitting device that is likely to be capable of being composed and, shaped so that it can be associated very easily with vaporiser bottles of shapes that are as varied as one could wish, while still allowing one to endow these miscellaneous vaporisers with presentation and aesthetic qualities that are new and favourable.

The invention therefore has as its subject the packaging of a sound-emitting device for a perfume vaporiser, of the type operated during the pressing of a button on this vaporiser, characterised in that it includes a first part attached to the button, equipped with electrical contacts that are closed or opened during the operation of this button, and containing a micro-loudspeaker positioned in such a manner that the directions of emission of the perfume from a vaporisation orifice and of the sound from this micro-loudspeaker are synchronised and in the same direction, with this first part fitting onto at least one second part that is capable of housing the other microcomponents of the sound-emitting device.

According to a characteristic of the invention, this second part is of minimum area in section, and of maximum length, so as to be able to accommodate as closely as possible to each other, all the micro-components of a sound-emitting device, with this packaging of minimum thickness being assembled by simple glueing to a surface of the vaporiser.

According to a particular arrangement, this surface is that of a cavity created in a wall of the vaporiser.

The invention thus specified in a very generic manner is suitable for diverse implementations so as to be applicable to all possible shapes of vaporiser.

The following description will be used to illustrate the characteristics and advantages of the invention, with reference to the appended drawings in which:

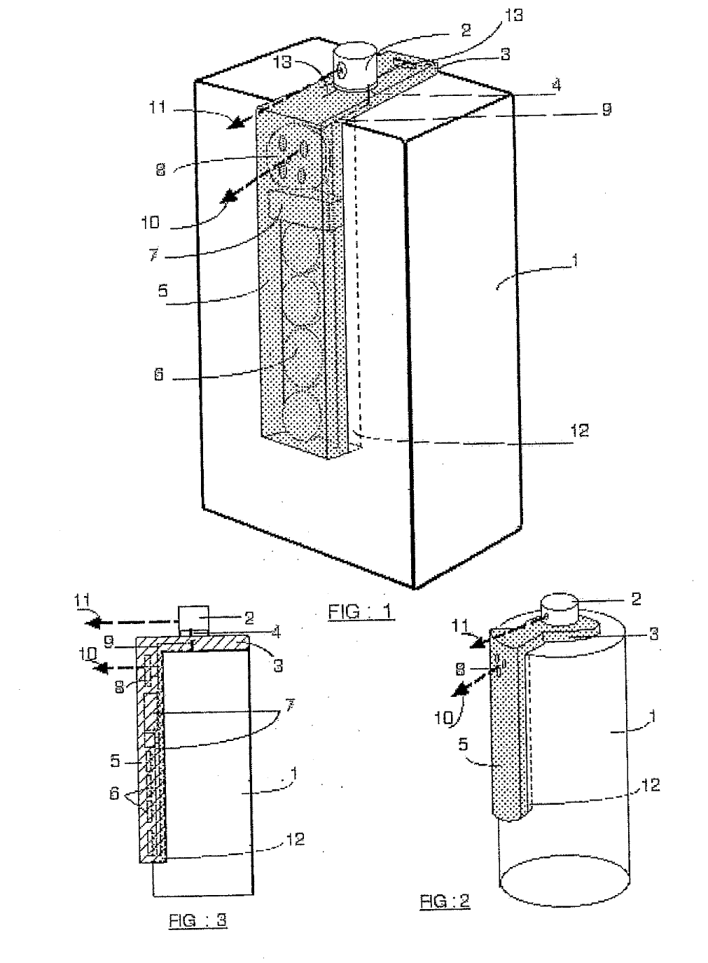

FIG. 1 is a schematic representation, in perspective, of a vaporiser of regular general parallelepiped shape, equipped with packaging according to the invention,

FIG. 2 relates to a vaporiser of general circular cylindrical shape (30),

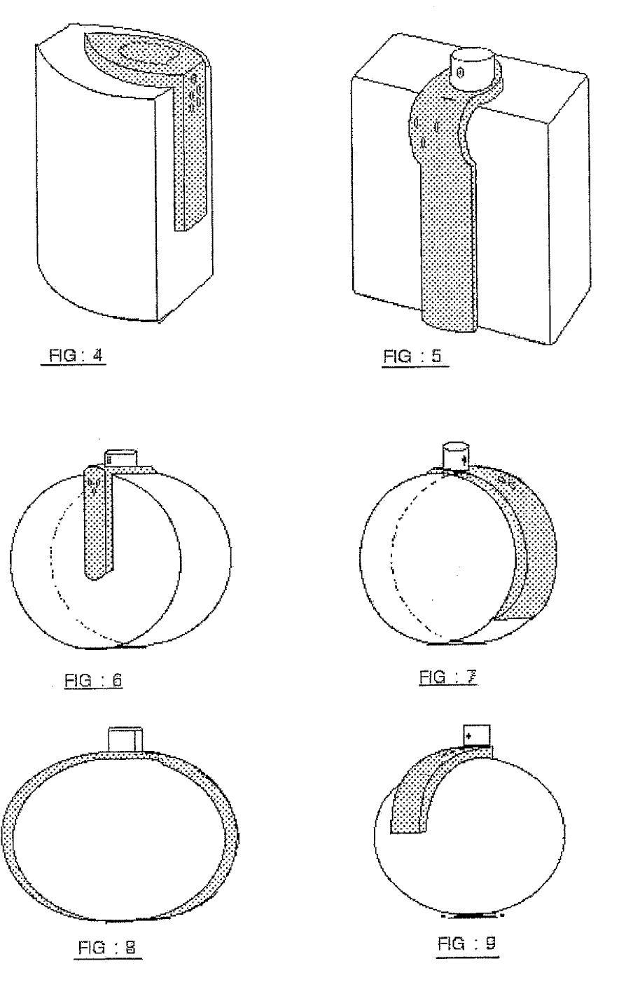

FIG. 3 is a view in profile of the vaporisers of FIGS. 1 and 2,

Schematic FIGS. 4 to 11 illustrate the large possible variety of applications of the invention.

Referring firstly to FIG. 1, representing a vaporiser with a bottle 1 of regular general parallelepiped shape and equipped with a button 2 that has a vaporisation orifice, and equipped with a switch 13 that operates the On/off control of the audio device. The packaging of the invention includes a first part 3 attached to the upper face of the bottle, and that surrounds the button 2.

The button 2 has a small vertical projection 4 that is capable of sliding in a vertical channel of part 3, in order to keep the button, and therefore the vaporisation orifice, in an angular orientation that is determined when this button is pressed. It is possible to use any other means of immobilising the button in its angular position.

The packaging includes another longilineal (tall and thin) part 5 bent over at a right angle so as to be attached to the vertical front wall of the vaporiser bottle 1. This elongated part 5 includes an internal channel, of which the minimum height and width dimensions are chosen for its section. It is thus possible to position the micro-components of a sound-emitting device, one after the other. In this non-limiting example, these micro-components include four flat circular cylindrical micro-batteries 6, an electronic microcircuit 7 for recording and storing an audio message, and the connection of this microcircuit to a micro-loudspeaker 8 as it is triggered when an electrical contact, illustrated in reference 9, is operated by the button.

In a more elaborate version, it is also possible to provide for the inclusion of a microphone, as is done in miniature pocket recorders, the smallest form of which can be as small as that of a ballpoint pen.

The loudspeaker 8 is placed as close as possible to the button 2 and is preferably oriented so that the direction 10 of its sound emission is parallel to the direction 11 of the emission of perfume by the vaporisation orifice.

In this example, the longilineal packaging 5, of a thickness that is as small as is allowed by the thickness of the micro-components used, is housed inside a recess 12 created in the front wall of the vaporiser bottle. If necessary or simply if preferred, this allows it to rise above the packaging on top of the wall only by a very small amount.

FIG. 2 corresponds to a bottle vaporiser of general regular circular cylindrical shape, equipped with packaging such as that which has just been described.

FIG. 3 is a view in profile of these two vaporisers of FIGS. 1 and 2.

FIGS. 4 to 11 schematically illustrate very varied embodiments of the invention, both with regard to the shape of the bottles and the shape and arrangement of the packaging of the invention attached to these bottles.

FIG. 4 is a vaporiser similar to that of FIG. 1. It differs from it in that the ovoid packaging is glued onto the upper face of the bottle and then is folded over onto a small lateral face, and where the type of button used here is a flexible membrane.

FIG. 5 shows that it is possible to choose a sinuous path for the elongated packaging.

FIG. 6 relates to a bottle of flat circular cylindrical shape, and the packaging is attached to a circular face.

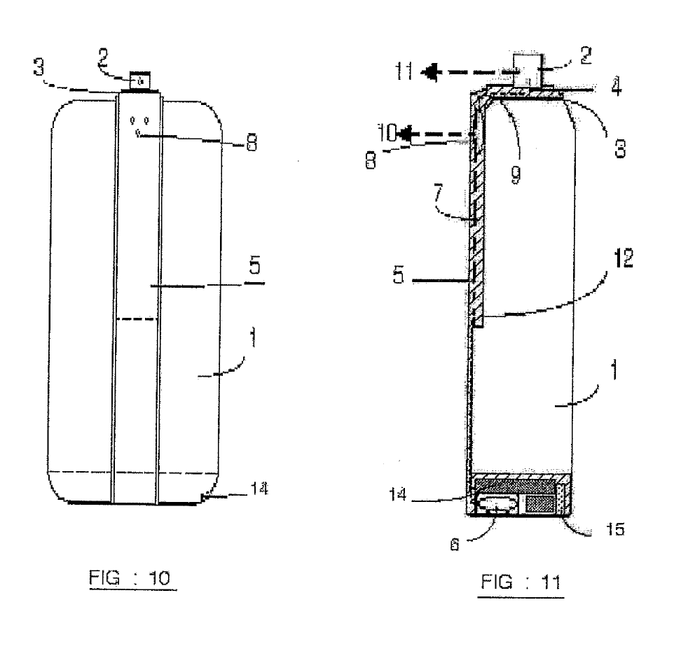

This packaging can be positioned laterally on either one side or both sides of the button respectively, as shown in FIGS. 7 and 8.

FIG. 9 relates to the case where the vaporiser bottle is of spherical shape.

Finally, FIGS. 10 and 11 represent the bottle 1 of the vaporiser equipped on its base 14 with microprocessors of the MP3 music player's type and fitted with an input for a USB connector 15 allowing downloading of new audio recordings.

It is now possible to understand the advantages of the invention, which allows the association of a vaporiser of any possible shape with a device to emit sound, of such configuration and size that it shows only in the most discreet manner in the overall view of the vaporiser, and also allows the use of the packaging walls to carry the customary markings of this type of vaporiser, such as the name of the perfume, and the brand of the perfume manufacturer.

The invention has been described above so as to clearly bring out its essential characteristics, and it is easy to envisage all of the possible application variants.

In particular, various models of vaporiser using a button with a vaporisation orifice, in the shape of a small regular cylinder, have been shown and described in the various figures. It would obviously be possible to use other types of button, such as those with a flexible membrane. The important thing is to ensure that the vaporisation orifice and the micro-loudspeaker are as close to each other as possible and that their directions of emission are close and parallel.

1. A sound-emitting device to emit sound from the packaging of a perfume vaporiser, of the type that is operated during the pressing of a button on said vaporiser, comprising a first part attached to the button, equipped with electrical contacts that are closed or opened during the operation of the button, and containing a micro-loudspeaker positioned in such a manner that the directions of emission of the perfume from a vaporisation orifice and of the sound from the micro-loudspeaker are synchronised and in the same direction, with this first part fitting on to, at least one second part housing other micro-components of the sound-emitting device.

2. The sound-emitting device according to claim 1, wherein the second part is elongated, so as to be able to accommodate, as closely as possible to each other, all of the micro-components of the sound-emitting device, said second part is assembled by simple glueing to an attachment surface of the vaporiser.

3. The sound-emitting device according to claim 2 wherein the attachment surface is a cavity created in a wall of the vaporiser.
